(19) United States
(12) Patent Application Publication
(10) Pub. No.: US 2008/0004946 A1
(43) Pub. Date: Jan. 3, 2008

(54) JUDGING SYSTEM AND METHOD

(76) Inventor: Cliff Schwarz, New York, NY (US)

Correspondence Address: KOPPEL, PATRICK & HEYBL, 555 ST. CHARLES DRIVE, SUITE 107, THOUSAND OAKS, CA, 91360, US

(21) Appl. No.: 11/759,687

(22) Filed: Jun. 7, 2007

Related U.S. Application Data
(60) Provisional application No. 60/812,653, filed on Jun. 8, 2006.

(51) Int. Cl. G06F 11/00

(52) U.S. Cl. 705/12

(57) ABSTRACT

A judging system and method for evaluating the performances of participants, the judging system being operated on a network computer. The judging system comprises a plurality of successive competition levels, wherein each competition level comprises a plurality of matches. Participants in the contest system register and are assigned a specific match in a competition level. Participants competing within the specific match review the entries of other participants and rank the other participants within the specific match. The winner of the match is eligible to compete in the next competition level.

### RELATED APPLICATIONS

This application is related to, and claims the benefit of, U.S. Patent Application Ser. No. 60/812,653, entitled A System, Method and Apparatus for Performance Competition, filed on Jun. 8, 2006, which is fully incorporated herein by reference.

### FIELD OF THE INVENTION

The present application is generally directed to a judging system and method for processing a large number of evaluations on a wide variety of topics. More specifically, embodiments of the invention are directed to a participant evaluation system and method, wherein each participant submits an entry for judgment in a predefined event, the entry then being ranked by each of the other participants in the particular event.

### BACKGROUND OF THE INVENTION

The judging and assessment of topics or items can provide valuable information. However, in most instances, the process of judging and evaluating topics or items of interest is cumbersome and slow, and depending upon the member of people involved, can extend over weeks or months. Indeed, depending upon the number of participants required to provide meaningful input, the mere collection of a large number of opinions or evaluations can create delays, which is then further delayed by the requirement to collate and summarize the opinions. In addition to time delays, costs are increased by the amount of time and personnel required to perform the collection and summarization of the collected data. The mere delay in the obtaining of information is, itself, a cost that can jeopardize advancement of a project or goal.

The burden of collecting opinions or having concepts and items evaluated affects many different fields. For example, the development of a new product line can be stifled by the need to know consumer preferences on the type of product that is needed or wanted by the consumer. The mere collection of consumer preferences may take weeks or months to obtain. In another example, as currently operated, most talent competitions do not provide meaningful feedback to performers in an efficient manner, either in time and/or cost. As there are many different issues in many different fields, the example of talent or performance competitions will be used to illustrate the types of problems that may be encountered; however, it is not intended to limit the disclosure.

Talent or performance competitions are popular events that allow unknown performers an opportunity to perform and receive evaluations, and possibly recognition, for their performances. Talent competitions are generally local in nature, and thus, do not provide exposure for the performers beyond the specific location. Although competitions on a national level may be available for certain types of talent, national level competitions can be expensive to enter, and can be extremely restrictive regarding the skill level required of a performer to enter the contest. Indeed, to enter many national talent competitions a performer may be required to compete in several qualifying competitions, each of which may be located in an inconvenient location and which may require high entrance fees. Accordingly, due to the economic requirements, many aspiring performers are restricted in their ability to travel and enter the types of talent competitions that are capable of providing them with an opportunity for recognition or national success.

With the advent of the World Wide Web and Internet, many individuals now have an opportunity to participate in many types of activities previously restricted due to high barriers of entrance, such as cost, or geographic restrictions. For instance, many individuals are now able to market and retail goods and services via the Internet which previously required a brick and mortar operation. In addition to business opportunities, many individuals have utilized the Internet, for example, via personal web sites to share personal interests and accomplishments, such as, their thoughts, music and videos. Indeed, the Internet provides a new forum for individual artist and performers.

Although individuals are now able to obtain exposure for their talents via the Internet, the likelihood that relevant persons, such as talent agents, or any substantial number of people, will view the performance is relatively low. Further, even if a particular performance is viewed by many people, the performer may not be provided with any response regarding the performance. Accordingly, the performer is not provided with valuable information that may allow the advancement of the talent.

Currently, some web sites have been developed which attempt to provide a specific forum for an individual performer. It is unclear, however, whether these web sites can provide sufficient response to individual performers regarding their performances. Further, many of these web sites require the input of a general audience, the composition of which may vary from performance to performance. Thus, the judging of one performance may comprise an audience that is completely different than that of another performance. This type of random audience participation creates a potential for inconsistency in the reviews of the performances, and does not assure a performer that qualified persons are reviewing and critiquing the performance.

A need in the industry exists for a judging system and method that provides a cost and time efficient manner of collecting and evaluating opinion or preference-type data. A further need in the industry exists for a judging system that creates a forum that provides a qualified and targeted audience to review entries, and that minimizes the cost for entry and participation for individuals. A still further need exists for a competition forum in which participants can compete regardless of skill level.

### BRIEF DESCRIPTION OF THE DRAWINGS

The detailed description of embodiments of the invention will be made with reference to the accompanying drawings, wherein like numerals designate corresponding parts in the figures.

FIG. 1 is a network system environment in accordance with a preferred embodiment of the instant invention.

FIG. 2 is a block diagram of a preferred embodiment of a method for a participant directed judging system.

FIG. 3 is a block diagram of a preferred embodiment of a method for a performance competition.

FIG. 4 is a schematic of a preferred embodiment of a user interface of an exemplar contest system in accordance with the preferred embodiment of FIG. 1.

FIG. 5 is a schematic of a preferred embodiment of a registration page in the exemplar contest system in accordance with the preferred embodiment of FIG. 1.

FIG. 6 is a schematic of a preferred embodiment of a profile page of the exemplar contest system in accordance with the preferred embodiment of FIG. 1.

FIG. 7 is a schematic of a preferred embodiment of a game page of the exemplar contest system in accordance with the preferred embodiment of FIG. 1.

FIG. 8 is a schematic of a preferred embodiment of a category page of the exemplar contest system in accordance with the preferred embodiment of FIG. 1.

FIG. 9 is a schematic of a preferred embodiment of a recording page in the exemplar contest system in accordance with the preferred embodiment of FIG. 1.

FIG. 10 is a block diagram of a preferred embodiment of a method for creating a multimedia presentation in accordance with the preferred embodiment of FIG. 1.

### SUMMARY OF THE DISCLOSURE

A judging system and method for evaluating the entries of participants, wherein the judging system is operated on a network computer. The judging system comprises a plurality of competition or evaluation levels, the competition levels ranging from a first competition level to a highest competition level, wherein each competition level comprises a plurality of matches. Participants in the judging system register and are assigned a specific match in a competition level. Participants competing within the specific match review the entries or submissions of other participants and rank the other participants within the specific match. In preferred embodiments, each participant can veto another participant's submission. The winner of the match is eligible to compete in a new match in the next highest competition level.

A feature of preferred embodiments of the invention is that allows participants to communicate with each other. An advantage to this feature is that social interaction is increased among the participants that improve the feedback and information each participant can receive regarding their entry or entries.

A further feature of preferred embodiments is that entries can be disqualified by the participants through the exercise of a veto. An advantage to this feature is that the entry of non-original materials is minimized or inhibited as participant's risk being eliminated for non-original material.

A feature of preferred embodiments of the present invention is an unlimited forum for competition. An advantage to this feature is that it allows an unlimited number of contestants to enter into competition.

A still further feature of preferred embodiments is that the ranking results can occur for each of the subsequent event levels within a short period of time, in part, based upon how quickly the participants vote. An advantage to this feature is that an unlimited number of participants can enter an event and a winner can be selected in a relatively short period of time as compared to traditional forums for obtaining user preferences requiring a series of event levels, such as contests having a series of competition levels.

Other features of preferred embodiments of the present invention are that users are allowed to submit third party entries into competition and utilize third party entries in their own work. An advantage to this feature is that contestants who cannot afford to enter their works into competitions can allow others to submit the work without cost to them. Another advantage is that performers that are talented in one area can enhance their performances by adding a complementary work into their own work, such as adding music to a video.

A feature of preferred embodiments of the present invention is that the judging system is configured to operate as a self-governing system. An advantage to this feature is that the system can ensure fairness as other competitors will monitor whether other submitted content is original material since each competitor has a financial incentive to prevent someone from winning that is not creatively entitled.

A further feature of preferred embodiments is that competitors of a match judge other competitors within the same match. An advantage to this feature is that the contest or game is interactive and fun for the users, and allows for more beneficial judging as the judging is performed by others with similar talents or interests.

A still further feature of the present invention is that it is self-perpetuating as long as participants register to play. An advantage to this feature is that participants, such as, artists, can continuously receive feedback from similar types of participants and if successful, an artist may be able to financial benefit by just playing the game.

The above and other advantages of embodiments of this invention will be apparent from the following more detailed description when taken in conjunction with the accompanying drawings. It is intended that the above advantages can be achieved separately by different aspects of the invention and that additional advantages of this invention will involve various combinations of the above independent advantages such that synergistic benefits may be obtained from combined techniques.

### DETAILED DESCRIPTION OF THE PREFERRED EMBODIMENTS

Preferred embodiments of the instant invention operate on a network, such as, for example, the Internet, or any other type of network system, including, an internet or an intranet.

Hardware Environment:

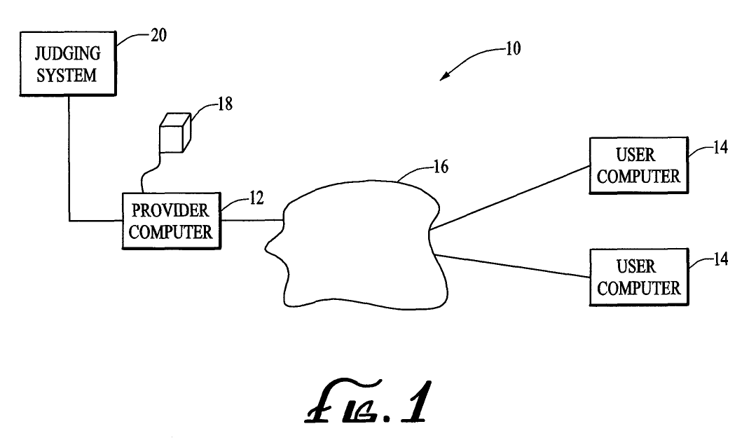

Preferred embodiments of the instant invention operate in accordance with a plurality of networked computers, such as, for example, a user computer and a server computer that are coupled together on a communications network, such as, for example, the Internet or a wide area network. FIG. 1 depicts a network system 10 that operates in accordance with preferred embodiments of the invention. In preferred embodiments, the network system 10 includes a server computer 12, or a provider computer, and at least one user computer 14, (a plurality of user computers are shown in FIG. 1), wherein the provider computer 12 and the user computers 14 are in electronic communication with each other via a communication link 16.

In some preferred embodiments, the network system 10 includes a plurality of either the provider computer 12, the user computers 14 or any combination thereof. The provider computer 12 contains client, contest and contest-related information, and other relevant data that is accessible by the user computers 14.

The provider computer 12 may comprise any suitable network device capable of providing content (data representing text, hypertext, photographs, graphics video and/or audio) for communication over the network. In preferred embodiments, the provider computer 12 comprises a programmable processor capable of operating in accordance with programs stored on one or more computer readable media (for example, but not limited to, floppy disks, hard disks, random access memory RAM, CD-ROM), to provide content for communication to client computers 14. The provider computer 12 may comprise, for example, but is not limited to, a personal computer, a mainframe computer, network computer, portable computer, personal digital assistant (such as, a 3Com Palm Pilot), mobile telephone, or the like. The provider computer 12 may include one or more internal data storage devices (not shown) for storing content for communication to a user computer 14. Alternatively, or in addition, the provider computer 12 may be coupled to an external data storage device, computer or other means, generally represented at 18, from which the provider computer 12 may obtain content for communication to user computers 14. In one embodiment, the external device 18 may comprise a further network device coupled in the network 16. The provider computer 12 is controlled by suitable software to provide the requested content to the requesting user computers 14, provided that various criteria are met.

In a preferred wide area network environment, such as the Internet environment, the provider computer 12 is controlled by suitable software to respond to a valid request for content by providing (or downloading) data in the form of, for example, one or more HTML files to the user computer 14 from which the request was made. It will be understood by those skilled in the art that this process involves communications through suitable servers, routers and other components, as is dictated by the particular network environment.

Each server 12 operates with a persistent storage means (not shown), for example, one or more of the fixed and/or removable data storage devices and/or data communications devices connected to the computer. The communication link 16 may include a public network, such as the Internet, a local area network, or any other suitable communications connection, hardwired, wireless, or a hybrid thereof.

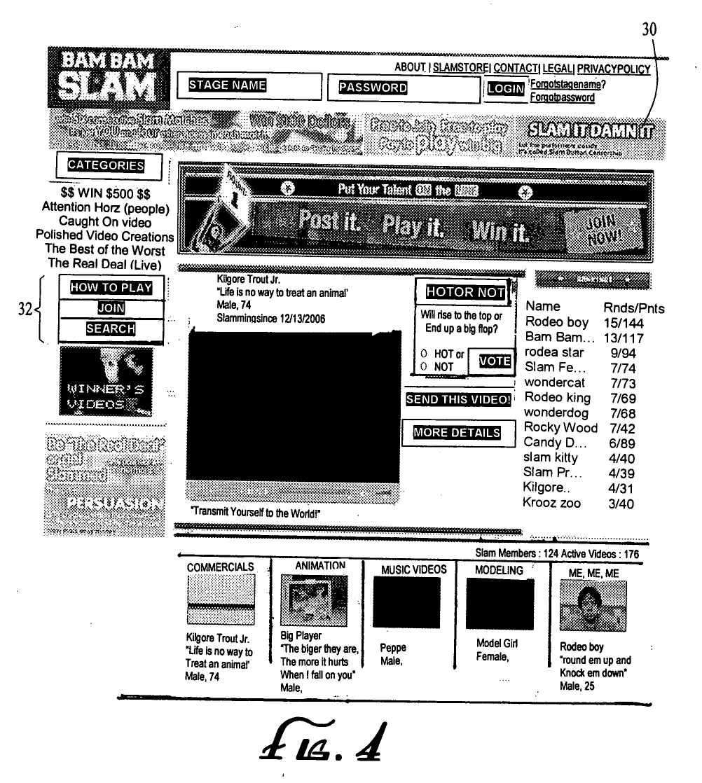

The user computers 14 may comprise any suitable network device capable of communicating with other network devices in the network system. In preferred embodiments, each user computer comprises a programmable processor capable of operating in accordance with programs stored on one or more computer readable media (for example, but not limited to floppy disc, hard disc, computer network, random access memory (RAM), CD Rom, or the like), a display device (not shown) for providing a user-perceivable display (for example, but not limited to visual displays, such as cathode ray tube (CRT) displays, light-emitting-diode (LED) or liquid-crystal-diode (LCD) displays, plasma displays or the like, audio displays or tactile displays), such as shown in FIG. 4, and a user input device (not shown) (for example, but not limited to, a keyboard, mouse, microphone, or the like). In one preferred embodiment, at least one user computer comprises a personal computer system having a CRT display, a keyboard and a mouse user-input device.

The user computers 14 are controlled by suitable software, including network communication and browser software to allow a user to request, receive and display information (or content) from or through a provider computer 12 on the network system 10. The client computers 14 operate in accordance with programs stored on a readable medium, including, but not limited to, floppy disks, hard disks, RAM and CD-ROM. The client computers 14 are any means capable of communicating with the provider computer 12, including, but not limited, to personal computers, kiosks and ATM-type machines. The client computers 14 access the server computers 12 via the wide area network or through some other remote access, such as, for example, by telephone, facsimile, personal digital assistant, pulse code system, web TV, or any other device or method that communicates alpha numeric data with a server.

### General Description of Preferred Embodiments

Embodiments of the present invention are directed to a judging system and method for evaluating and ranking entries or submissions entered into an event, wherein the event is defined by a specific topic or subject matter, such as, for example, a singing contest or a contest to determine the best line in a movie. In preferred embodiments, the judging system 20 resides on, or is coupled to, the network system 10 and is accessible to the user computer 14 via the provider computer 12. In preferred embodiments, the judging system can be self-perpetuating and self-operating, and can simultaneously provide a set of events, each event defining a different topic, wherein each event comprises a plurality of event levels and a plurality of matches at each event level. Matches at each level are ongoing and can commence at different times within a level.

In preferred embodiments, the judging system and method can be used to render an opinion, judgment, evaluation or ranking for any type of concept or physical item, including, but not limited to, ideas, content, live performances, and creative works (such as photographs, videos, audio content, art work). The judging system is intended to be utilized in a wide variety of different scenarios, such as, for example, marketing surveys to determine consumer preferences, to determine prevailing opinions, to select the best line in a movie, to select the funniest scene in a movie, to select the best performance among actors, and the like.

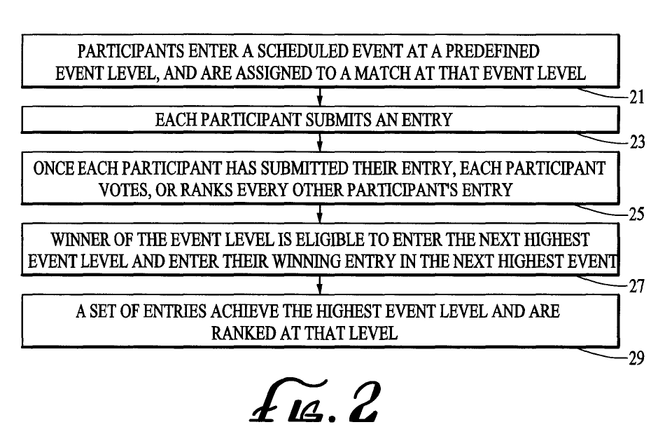

With reference to FIG. 2, in preferred embodiments, participants enter a scheduled event at a predefined event level and are assigned to a match having a predefined numbers of participants 21. The event identifies the subject matter to be considered by each of the participants. For example, the event may be a singing contest or an event to determine the funniest line in a movie. In preferred embodiments, each participant submits an entry 23. The participant's entry represents that participant's selection for the topic of the event. For example, if the event is a singing contest, the participant may submit an audio or video file of themselves singing, perform live, or submit an audio or video file of another person singing a song. If the event is an event to determine the funniest line in a movie, each participant would submit that participant's selection of the funniest movie line. In each instance, the topic of the event will determine the type of entry and the medium of the entry.

Once each participant has submitted their entry, each participant is required to vote, or rank every other participant's entry 25. In preferred embodiments, only the participants are entitled to rank the entries. In other preferred embodiments, past participants may also be entitled to rank the entries in addition to the currently participating participants. In all instances, the participant is not allowed to vote or rank their own submission. The winner of the match is eligible to enter their winning entry in the next highest event level. As matches are concluded at each event level, information regarding each submitted entry is accumulated, that is, the entry is favorable, not favorable, or somewhat favorable. Participants gain information regarding their selected entry which may determine whether the participant continues with the entry or concludes that the entry is not favorable.

Each event level has a plurality of substantially simultaneous matches. Each match operates independently from every other match. A winner is selected from each match at a specified event level. Each of these winners is eligible to submit their entry in the next highest event level and have the entry ranked against other entries that won the prior event level 27. At each event level, the entry is ranked by a new set of participants. Eventually, a set of entries achieve the highest event level and are ranked at that level by the participants who have won the series of event levels 29.

The judging system is configured to provide substantially immediate results and allow an entry to be judged at various levels by a substantial number of other participants. Indeed, as the idea or content progresses through each level, the participant and the judging system is quickly offered information as to the acceptability of the concept or favorability of, for example, a performance.

As stated above, the judging system and method can be implemented in a wide variety of subject matter. Although differing subject matter may include varying specific implementation, the fundamentals of the judging system and method are applicable. Accordingly, for purposes of illustration, the disclosure will be directed to the example of a contest or performance system. However, it is to be understood that this is intended to be illustrative only, and is not intended to be limiting.

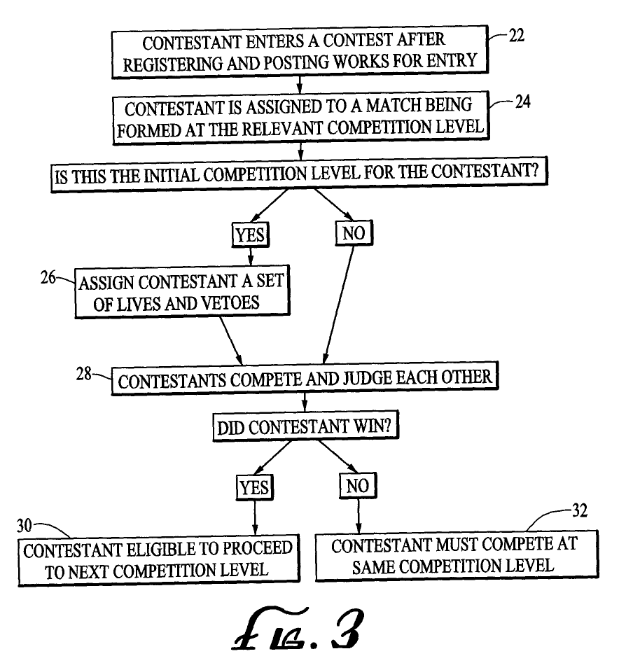

In the illustrative example of the contest or performance system and method, embodiments of the present invention are directed to a contest system and method for evaluating performances of contestants in a contest. Overall, in preferred embodiments and with reference to FIG. 3, players, also referred to as competitors, contestants and performers, can enter a contest after registering and posting creative works, such as, a video, photograph, or audio clip, or by performing live 22. The contest system is a media-posting and interactive performance game. Appropriate media, or works, to post, include but are not limited to, video, audio, or photographic files. To participate in the competition, competitors need a content file for submission to the contest system, wherein the content file can be created by the participant or a third party. If a participant creates their own content file, it is useful, but not necessary, if the participant has a camera and a microphone attached to their computer, such as a Macintosh or personal computer. A higher quality computer will produce better content for viewing by other competitors who are ultimately the judges. Each competitor must decide what auxiliary equipment will create the optimum effect. If a competitor is playing by posting audio tracks or video clips, they will be notified by electronic mail messages when voting needs to occur or if they have won or lost.

Contestants initially enter the contest at the lowest performance level and are assigned at least one of the matches being formed at the lowest competition level 24. Once a predefined number of contestants register and are assigned a specific match, that match can commence. It is to be understood that a plurality of matches can occur at substantially the same time for every competition level, and further, as the contest is self-perpetuating, as more contestants register for the contest, matches on each competition level are continuously formed and ongoing. For example, twenty separate matches can be occurring substantially simultaneously on a first competition level, and fifteen separate matches can be occurring substantially simultaneously on a second competition level. In this instance, the individual matches may have each commenced at a different time from any other match, close in time or at the same time. As sets of matches for the first competition level end, new matches are continuously beginning such that competition at the first level can continue, theoretically, indefinitely. More specifically, the competition can continue for as long as contestants register to compete. This pattern repeats for each competition level as matches end at the lower competition levels and contestants register for the next higher competition level. Thus, a continuous and self-perpetuating contest is created.

It is to be understood that several different contests for various types of talents can simultaneously be created and operated. For example, a contest for singing, videography and photography can be simultaneously ongoing, each with its own set of competition levels and matches within each competition level. Contestants for a particular contest continue participating in the same contest with the same entry by proceeding through each successive competition level. A contestant is allowed to enter more than one contest and may be competing with several entries in different types of contests, or may be competing with several different entries in the same type of contest.

In preferred embodiments, with reference again to FIG. 3, upon the initial entry into the game or contest, each player is assigned a predefined number of chances, also known as lives, and vetoes (discussed below), for the game 26. During the contest whether a player has any lives determines whether that player can continue to compete. The originally assigned set of lives is appurtenant to the series of consecutive matches or rounds for the specific game. Thus, a player entered into several different contests will receive a set of lives for each contest. In one preferred embodiments, the number of lives and vetoes is three (3).

As a player competes in each match, the player performs, is judged by the other competitors in the match and, in turn, judges the other players 28. A player must win the match to advance to the next competition level where he will compete against players that have also won the same number of matches or succeeded in the prior competition level 30. As a player wins, the player advances to the next consecutive competition level. If a player does not win the match, the player must reenter the competition at the same competition level 32. In some preferred embodiments, the player loses a life if the player does not win the match.

As stated above, upon initially registering for a contest, a player is assigned a predefined number of vetoes or ‘slams’. In this regard, in addition to a predefined number of lives, each player is given a predefined number of vetoes that can be used to veto other players' performances throughout the contest 26. A veto is a way for players to remove other players in the match from the contest, or at least contribute to their removal. Since the number of vetoes a player can exercise is limited, a player may retain his vetoes to utilize against other players in later matches of play.

If a player vetoes a performance, an official veto or ‘slam’ is recorded against that performance. In preferred embodiments, once a specific performance receives, for example, three vetoes from three different players (or a predefined number of players), the player associated with the performance loses the currently entered match and must replay at the same level. If a player or contestant receives the maximum number of vetoes, the player is “slammed out” and can no longer participate in evaluating the content of the remaining players. If the ‘slammed out’ player has already voted or ranked the other players, in some preferred embodiments, the votes or ranking is voided. The contestant's ability to receive vetoes is then reinstated, that is, vetoes will again accumulate against the contestant. Once a player has lost all three of the assigned lives, the player must begin the contest from the beginning, that is, must re-enter at the initial level, and pay a new entrance fee. As discussed above, a player may strategically retain his vetoes to use against other players in higher level competition levels.

If a player only receives one veto in a match, but wins the match, the veto is recorded against the performance and carries into the next match. In some preferred embodiments, the player will still lose a life for receiving the veto. In other preferred embodiments, by winning the match, the player will not lose a life. If that player loses the match, the veto will be recorded against the performance and the player will lose a life. In some preferred embodiments, if the player that has been vetoed ties with another player, each receiving the highest score, the player does not lose a life. It is to be understood that the specifics regarding the manner of progression in the performance competition can be altered.

When a contestant registers to play in the contest system, the contestant is required to pay an entrance fee of money or tokens. In some preferred embodiments, players can play free rounds. However, in some instances no reward is provided for winning free rounds. Upon registration, as discussed below, the contestants are arranged into small groups of a predefined number of players which can vary depending on the length of the content that each player must evaluate and the number of matches.

Each contestant must watch or listen to each of the other contestants' performances or works (video, photo, song, or live performance) and then rate or rank it from best to worst. The contestants do not rate themselves. The rating is accomplished by assigning numbers from the very best to the worst. For example, in one preferred embodiment, in a five-person match, the rating for four-persons could be assigned as follows: a ranking of 4=best, a ranking of 3=second best, a ranking of 2=third best, and a ranking of 1=worst. The total scores for each of the five players are added up and the player with the most points wins that match and proceeds to the next level to compete with a new set of players that have also won the same number of levels.

A player advances to the next higher level by winning a match. The winner that progresses to the next level wins an award of money or tokens. In some preferred embodiments, although the award or token can be used to pay for entrance fees in subsequent matches, the player cannot take possession of the award or token, that is, cannot withdraw the award from the game, until the player reaches the highest level and is successful at that level. In other preferred embodiments, the player can ‘cash out’, that is, take the tokens or award without proceeding to the next level. If the award is game credit, the player can use the game credit at a later time. In one preferred embodiment, the award is double to the amount of the entrance fee. In other preferred embodiments, the award could also be a higher multiple of the entrance fee depending on the number of rounds, players in each round, the number of lives that a player receives at the start of the game, and the number of lives the player has at the end of the game. In one preferred embodiment the following is an example of a pay-out chart based on doubling the entrance fee. Similar pay-outs schedules could be created by tripling the entrance fee and so on:
Round 1—1 token—Win 2
Round 2—2 tokens—Win 4
Round 3—4 tokens—Win 8
Round 4—8 tokens—Win 16
Round 5—16 tokens—Win 32
Round 6—32 tokens—Win 64
Round 7—64 tokens—Win 128
   Once a competitor wins a match, the competitor is allowed to compete in the next competition level and must pay a new entrance fee for the new level. In preferred embodiments, the player uses the tokens received in the prior winning match. In preferred embodiment, a competitor must win a set number of competition levels to win a monetary reward. If a competitor wins a predefined number of competition levels, the competitor is eligible to receive a monetary prize or other predetermined award once the contest provider has confirmed compliance with all of the rules.

In general, the players that do not win a match lose a life and must replay at the same level. If a player loses three times (or depending on the number of predefined lives assigned by the contest system), the player must restart the competition at the initial competition level. When players tie in a match, in some preferred embodiments, the players do not advance; however, in some preferred embodiments, they do not lose a life. In these instances, each player must simply replay at the same competition level; however, each player plays against a new group of players. A player cannot advance to the next competition level unless he is the sole winner of the current competition level.

In some preferred embodiments, a tie-breaking method is employed to allow the advancement of one of the players in the tie. For instance, in one embodiment, a winner is established by determining which player has the highest number of accumulated points in the game. In some embodiments, points earned at a level are multiplied by the number of lives a player has at the end of the match at that level. In this respect, players who have played more matches will not have an advantage over players that have played less matches and been more successful. For example, a player losing a first match at a first level, but winning the second match at the first level, will have his total accumulated points multiplied by two, the number of remaining lives. A different player that has played a first match at the first level and won will have his total accumulated points multiplied by three. In this regard, the player that has been more successful and that has advanced more quickly will typically not be penalized.

Embodiments of contest system allow users to play until they win enough rounds to be a highest level winner. In some embodiments, the highest level winners are awarded a prize in the form of award checks; however, other types of suitable prizes can include, but are not limited to, non-monetary awards, credit refunds on a credit card, or a deposit into a debit account. Prior to disbursing the award, the providers of the contest system evaluate the submitted performance or work to ensure that the submission is original material content, or material within predetermined guidelines promulgated by the provider. If a contestant is using non-original material or material not within the predetermined guidelines, that player will not receive the award. Other contestants have the option of removing players from a game with the use of the veto button if they feel the submitted performance is non-original material or offensive material. In some preferred embodiments, a ‘flag’ button (not shown) can be used to flag the submission as non-original or inappropriate. If a submission is flagged, the provider will review the material and determine whether it should be removed from the contest. In this regard, a player is not required to utilize a veto. It is advantageous for a contestant to use one of these options to remove inappropriately submitted works.

In preferred embodiments, the contest system 20 resides on, or is coupled to, the provider computer and is operated on a computer network 10, or any other networking device, including, but not limited to, wireless and cellular devices. With reference to FIG. 4, users, such as competitors, access a user interface 30, for example, a web site page. The user interface includes links 32 that allow a user, for example, to register with the contest system, view the types of available contests and learn how play. Upon clicking on a link, a user is transmitted to the corresponding web page identified by the link.

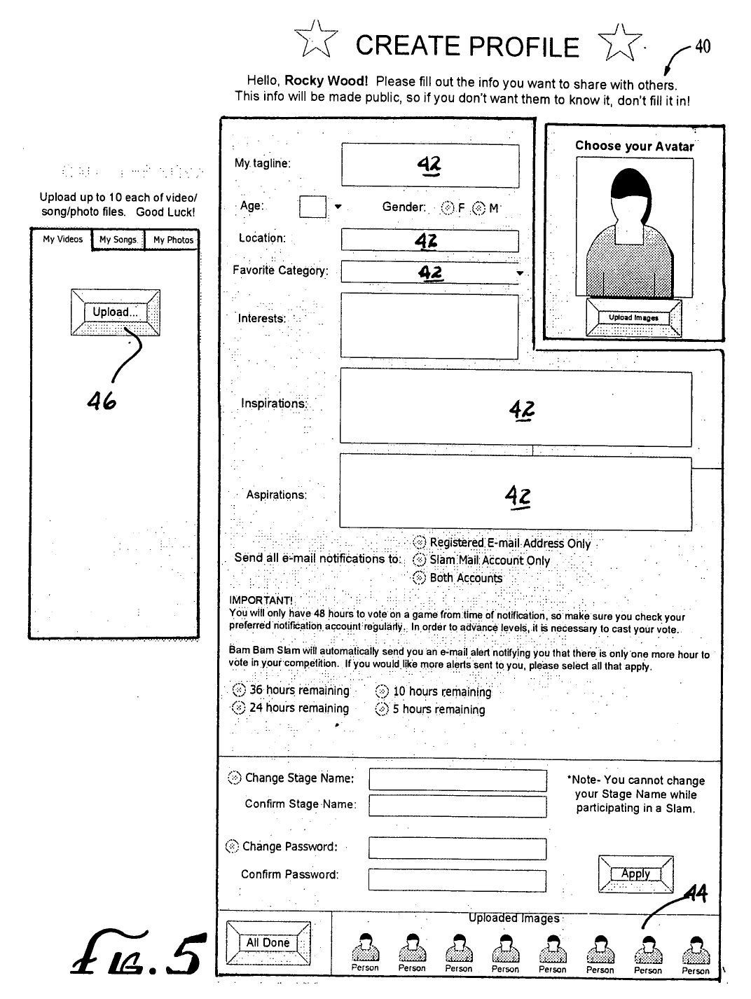

If a user desires to compete in a contest, the user must register with the contest system. Upon linking on the “Join” or “Register” link, the user is transmitted to a registration page 40 that allows the user to create a profile. With reference to FIG. 5, the user inputs personal user information via input boxes 42, including, but not limited to, name, address, and email address. The user can also input contest information, including, but not limited to, account information (stage name and password), slogans to be associated with the user's stage name, and talent or competition information. Further, the user is able to upload avatar images 44 that can be used in association with user content, that is, performances which may be used in competition. The contest information creates a portion of the user profile that is associated with the user during competitions.

The registration page 40 further allows the user to upload data files that the user may desire to enter into a competition via an upload link 46. The data files represent performances by the user, or creative works of the user (collectively referred to as “works”), such as singing, acting, reciting a poem. In some preferred embodiments, the data files can also represent events captured on tape, such as, a funny event or an animal act. Thus, the data files can include, but are not limited to, videos, music and photography files.

In preferred embodiments, upon uploading the data files or works, the user identifies the category for competition, and also enters information about the file. For example, data file information can include, but are not limited to, the title of the work, keywords (for searching), a description of the work, and credits for the work. Further, the user can identify the avatar image to be associated with the work. The uploaded content is stored in the database 18 in association with the input information regarding the category for competition and file information. In some preferred embodiments, a flag is set that indicates the content is not currently active, that is, the content is not entered into a competition. When content is entered into competition, the flag setting is changed such that the content is identified as currently active.

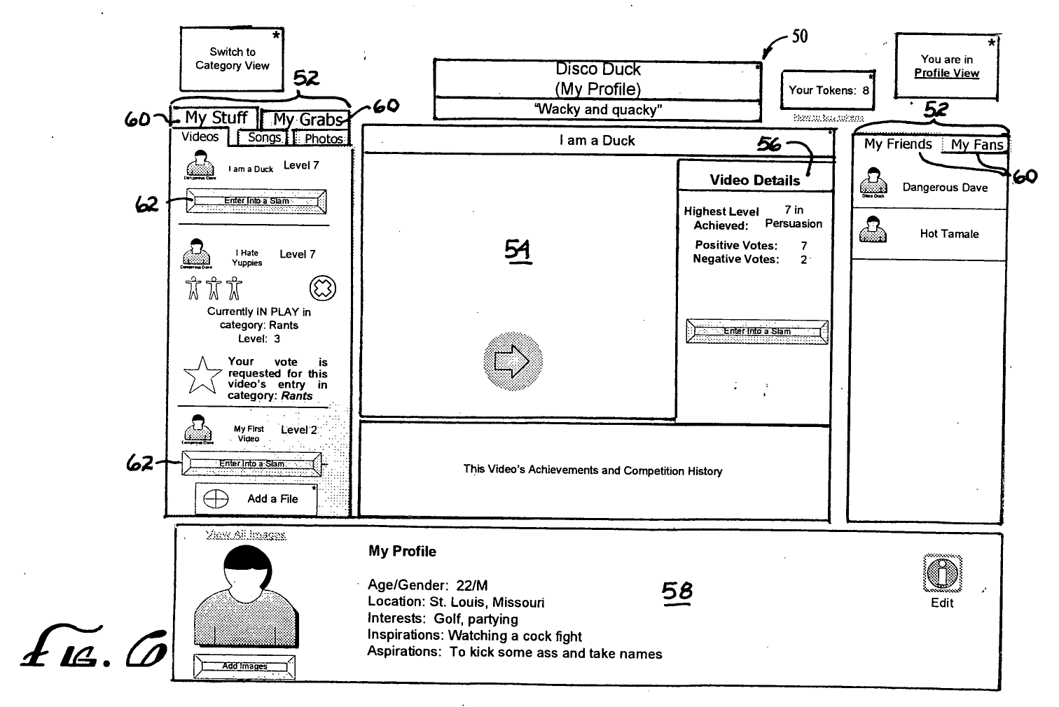

Once the user registers, the user can log into the contest system 20. With reference to FIG. 6, upon log in, the user is transmitted to a user profile page 50. The user profile page 50 is the user's portal to managing and uploading works, entering works into competitions, editing the user profile and avatar images, viewing friends in the system, managing inventory of other user's works, and reviewing the status of any current contests.

The user profile page 50 comprises menu bars 52, a viewer 54 for viewing works and a content pane 56. In some preferred embodiments, the profile page 50 further includes a user section 58 that lists portions of the user profile. The menu bars 52 each include at least one user related link 60. User related links allow the user to manage their own content, interact with other users in the contest system, manage the user's collection of other competitor's works and review current contests. In one preferred embodiments, user related links 60 can include, but are not limited to, my stuff, my grabs, my friends, and my fans. It is to be understood that any name can be assigned to the links and the ones included are intended to be illustrative.

The link “my stuff” lists, via categories, the status of user uploaded content. Each listing can depict the details for the content, including displaying the title and highest level achieved. Any content not currently in a competition will include an “Enter” button 62 disposed adjacent the listing which is coupled to the listing such that depressing the ‘Enter’ button will commence the process for entering the content into a competition. The information listed for content that is currently in competition includes, but is not limited to, the number of ‘lives’ remaining for the current contest, the number of vetoes remaining for the current contest, the category of the competition, the competition level and a link that will transmit the user to the voting and results page for the specific competition. For instance, in FIG. 6 three videos are listed. The first listed video is entitled “I am a Duck”. This video has attained Level 7 eligibility in the competition and is available to be entered into a contest. The next listed video, entitled “I hate Yuppies” is currently in play. This video has been entered in the Rants category and is competing at Level 7. Finally, the last listed video entitled “My First Video” has attained Level 2 eligibility and is currently available for competition.

The link “my grabs” lists the user's inventory of other users' works, that is, other competitors' works. The listing of other user's works will include the same type of information included for the user's own content.

The link “my friends” lists the other competitors in the contest system authorized to communicate with the user via email. The link “my friends” lists the stage name and avatar image of the other competitor. If the user links to a particular ‘friend’, the user will be transmitted to the “friend's” profile page which will contain information associated with the “friend”.

The link “my fans” lists the information regarding other competitors that have saved, or grabbed, the user's content. This allows the user to determine whether particular content is popular.

The viewer 54 is a box or media player that displays content. In preferred embodiments, the viewer is any type of display device capable of displaying any type of media, including multimedia material, including, but not limited to, a media player, a flash media player, a music player, a photograph player, or a combination of players. In some preferred embodiments, the viewers include a Windows® Media Player, and a QuickTime® player. In some preferred embodiments, to facilitate operation of the system, the provider server 12 converts the player's submitted media file, for example, video or audio file, into a predefined format. This ensures that the submitted file displays in substantially the same manner on every player's computer to eliminate, or at least minimize, differences in the display qualities between the players which could affect the ranking of the submission between players.

The content pane 56 is a pane or window for displaying information about the content currently displayed or playing in the viewer 54. If a user selects content that is currently not in play the content will populate the viewer, and will include information regarding the title and the content's statistics, such as, the highest level achieved and the number of positive and negative votes received. If the content is currently in play, the content pane 56 will also display the status of the current competition. If the user has not yet voted in the competition, the user will be advised to vote. If the user has voted, the user will be advised as to whether all of the other participants have voted.

If the user decides to enter content into a competition, the user activates the “Enter” button 62 associated with any work currently available for competition. Upon activating the “Enter” button, the user is transmitted to a contest entry page. The contest entry page will list the name of the selected content, the category associated with the content, the level of competition and will advise the user of the number of payment tokens remaining after entry into the competition. In some embodiments, the user can change the category into which to enter the content, and change or view the file details for the content. If the user does not desire to enter the content, the user can return to the user's profile page 50 and the content will not be entered into the competition. If the user enters the contest, the user will be transmitted to a confirmation page, wherein the user will be assigned a player number and notified as to how many additional players, if any, are required before the match can commence. The user can return to the user's profile or proceed to the game room from the confirmation page by depressing an appropriate link.

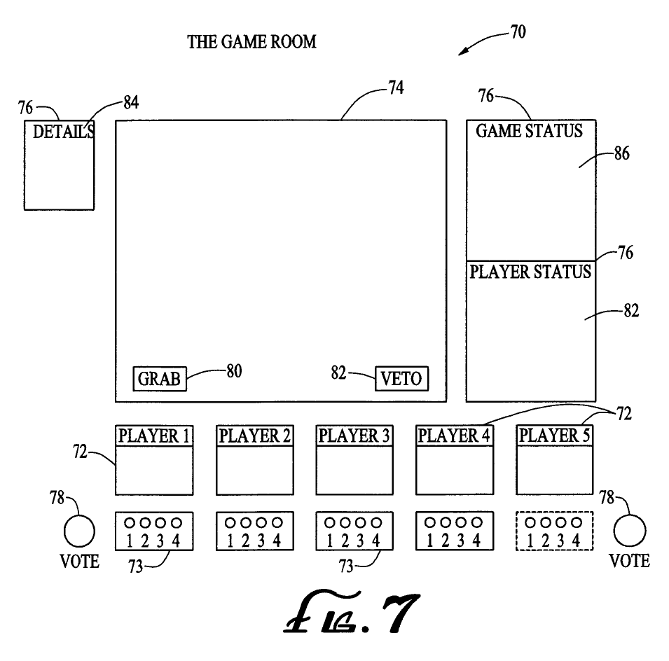

If the user clicks the link to proceed to the game room, the user is transmitted to a game page 70. With reference to FIG. 7, the game page 70 comprises competitor links 72, a voting tool 73, a game viewer 74, content panes 76 and a vote button 78. The competitor links 72 are a set of links that accesses each competitor's profile information and content information. Each competitor is identified by a player number and the avatar image associated with the entered content.

The voting tool 73 is a tool by which each player ranks or votes on the entries of the other players. With reference to FIG. 7, the voting tool 73 is a series of buttons each of which provides a ranking selection; however, any type of tool that allows the players to rank or vote is suitable, including, but not limited to, a pull down button or write in box. Assuming, for example, that player 5 has accessed the game room, the voting tool 73 would be active for all players, except player 5, as a player cannot rank themselves.

The game viewer 74 is a box or player that is configured to display content, including, but not limited to, static content and videos, or to play music. The game viewer 74 is coupled to a ‘grab’ button 80 and a ‘veto’ button 82. If the viewing user depresses or clicks on the ‘grab’ button, a relational link between the content displayed in the viewer 74 and the identification of the viewing user will automatically be created and stored in the database 18, and further, the title of the content will automatically be listed with the viewing user's listings of other competitor's content, that is, in association with the ‘my grab’ link. If the viewing user depresses or clicks on the ‘veto’ button 82 a negative vote is recorded and stored in the database 18 in association with the displayed content. The negative vote is also stored in association with the voting user. The veto vote can potentially cause the displayed content to be disqualified from the contest. As previously discussed, if specific content receives a predefined number of vetoes in any single match, or series of matches, the content loses the currently entered match and the player must re-enter the contest at the same competition level.

The content panes 76 are dynamic predefined windows or panes on the web page that are configured to receive information related to the selected content, user and game status. In one preferred embodiment, the content panes include a player pane 82, a content detail pane 84 and a game status pane 86. The player pane 82 displays information regarding each of the players, such as whether the player has voted and how many submissions have been viewed by the player. The content detail pane 84 displays information regarding the content currently displayed in the viewer 74, including the description of the work, highest level of achievement, total number of views (number of times the work has been viewed by anyone), amount of awards won, number of free competition levels won and lives remaining in contest. The game status pane 86 displays a summary of the game statistics for the currently playing content. For example, the game status pane 86 displays the amount of time in the game, how many times the content has been viewed by a player and which players have voted. The amount of time remaining in the game dictates the amount of remaining time for every player to vote. Once the game time has elapsed, any player that has not yet voted is disqualified from the game.

To vote on the competing content, the user should review each competitor's entry. To view a particular competitor's content the user selects the competitor's link 72. Upon selection of the competitor's link 72, the content entered into the competition by that competitor is transmitted from the database 18 and displayed in the game viewer 74. Additionally, information regarding the selected content is transmitted from the database 18 and is populated into the player pane 82 and content detail pane 84. Once a user has reviewed each entry, the user can rank the entries. If the user is satisfied with the ranking order assigned to the entries, the user depresses or clicks the vote button 78 which transmits the user's rankings of the entries to the provider computer 12. As discussed above, a user cannot rank his own entry.

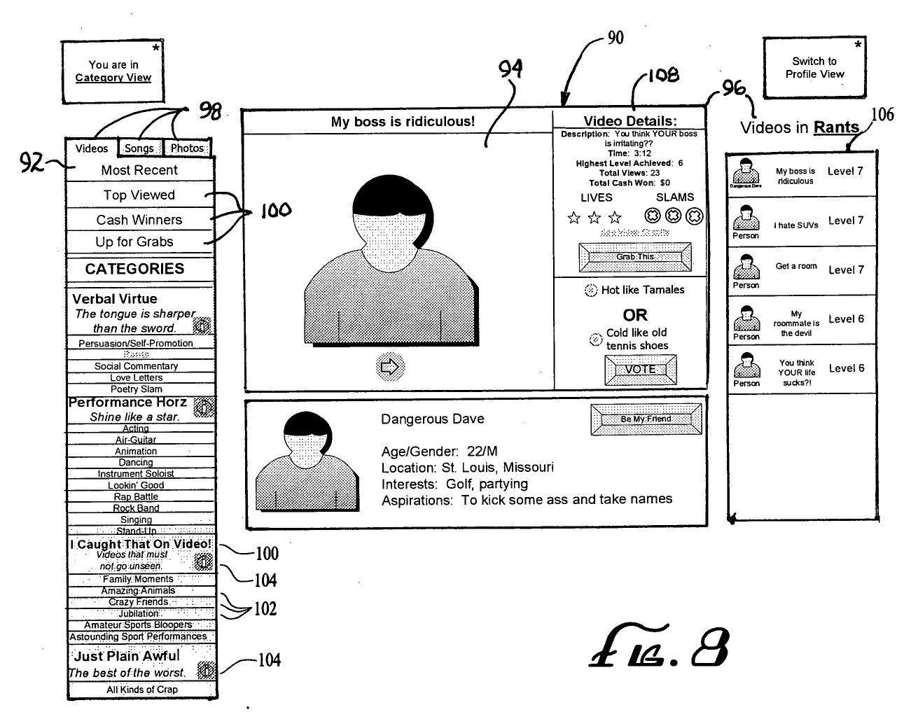

In addition to competing in a match, users or competitors can simply browse the content of other competitors that has been uploaded to the contest system. With reference to FIG. 8, users of the contest system can view a category page 90. The category page is a web page similar to the profile page, except that it can provide the status for all of the competitions in each category. The category page 90 comprises a menu bar 92, a viewer 94 for viewing works and content panes 96.

The menu bar 92 comprises category links 98 for each of the broad genres or topics for each category 100. The broad genres or topics typically identify the type of content. In one preferred embodiment, the broad genres include, but are not limited to, videos, songs and photographs. Within each broad genre is a listing of broad subject matter categories 100. Finally, within each broad subject matter category heading is a listing of specific categories 102 of competition. For example, in one preferred embodiment, the genre ‘Videos’ lists the broad subject matter categories ‘Verbal Virtue’, ‘Performance Horz’, ‘I Caught That On Video’ and ‘Just Plain Awful’. Within each of these broad categories, the specific categories are listed. For example, included within the broad subject matter category ‘Verbal Virtue’, the specific categories include, but are not limited to, ‘Persuasion/Self-Promotion’, ‘Rants’, ‘Social Commentary’, ‘Love Letters’ and ‘Poetry Slam’. Each of the category headings is a link that is coupled to the listing of currently active content within the category. If a user clicks on the menu bar link for another broad genre category, the listings for that category will be displayed. It is to be understood that the titles of the categories can change and these are merely illustrative.

An informational link 104 resides adjacent each category, wherein the informational link is coupled to a window that includes an explanation of the types of entry acceptable for that category. In some preferred embodiments, if a user scrolls the computer input device, such as a mouse, over a category, a pop up window appears that contains the description of the category. In some embodiments, a combination of approaches is used to display information about each category.

The viewer 94 is a box or media player that displays content. In preferred embodiments, the viewer is any type of display devices capable of displaying any type of media, including multimedia material, including, but not limited to, a media player, a flash media player, a music player, a photograph player, or a combination of players. In some preferred embodiments, the viewers include a Windows® Media Player, and a QuickTime® player. In some preferred embodiments, to facilitate operation of the system, the provider server 12 converts the player's submitted media file, for example, video or audio file, into a predefined format. This ensures that the submitted file displays in substantially the same manner on every player's computer to eliminate, or at least minimize, differences in the display qualities between the players which could affect the ranking of the submission between players.

The content panes 96 are dynamic predefined windows or panes on the web page that are configured to receive information related to the selected content and active content for a given category. In one preferred embodiment, the content panes include a category status pane 106 and a content detail pane 108. The category status pane 106 displays a listing of all the content currently active in that category. Upon clicking on a category link in the menu bar 92, the category status pane 106 is populated with the list of content, for example videos, that are currently active in the selected category. The listing of currently active content is identified, for example, from the content flagged as active for that category in the database. The listed content is sorted by competition level.

The content detail pane 108 is a pane or window for displaying information about the content currently displayed or playing in the viewer 94. If a user selects content that is currently not displayed in the viewer the content will populate the viewer, and will include information regarding the title, a description and the voting statistics. Additionally, information regarding the content's creator is displayed.

In addition to competing with one's own content, embodiments of the contest system 20 allow users to enter and compete with other competitor's content, or to utilize other competitor's content within their own content. For example, to add music content to a user's own video content.

In one preferred embodiment, competitors that do not wish to enter into a contest can register and post their content. In these instances, the content is identified as available to be represented by another party. Some competitors are good ‘talent scouts’ and have talent in selecting good third party content.

In some preferred embodiments, the contest system is configured to award people who are gifted in being able to spot talent. As such, competitors uploading content are allowed to indicate whether they want their material to be entered into competitions by other players. Someone who creates content can post the works and another member can pay the entrance fee for a competition. In one preferred embodiment, if the content wins, the parties split the monetary or token winnings equally. The outcome is a contest system of creators and investors each being rewarded for their talents. Further, regardless of whether the content wins, the entry of the content by another competitor reassures the creator of the content that someone believed the content to be good. If the content wins, the selector of the content has some validation that his selection skills are good.

As stated above, in addition to simply entering another competitor's content in a competition, the contest system is configured to allow a sharing of content or collaboration of content such that a combined work is created. For example, contestants that compete in a music composer category create music that becomes sorted by category and by how high a competition level the work has achieved. At the composer's choice, the music can be made available for filmmakers and video artists to download for use in their films. If the music is used on a video posted by the contest system the composer can win additional rewards if the music is used in a high-ranking video. In other scenarios, casting actors or competitors engaging in joint collaborations with musicians, actors, scriptwriters, directors, and video artists can collaborate to create a work having multiple talent disciplines.

Although the foregoing disclosure has been described with particular embodiments, the disclosure is not intended to be limiting, and can include other features or variations. For example, in another variation on the sharing of content, in one embodiment, the contest system accepts competition videos auditioning as a host for a section of the web site. In one embodiment, the video clip is the opening 15-second host section of the site. These clips can be posted and entered for competition. Whichever performance is leading in the highest round is the performance that is displayed when other users go to the category page.

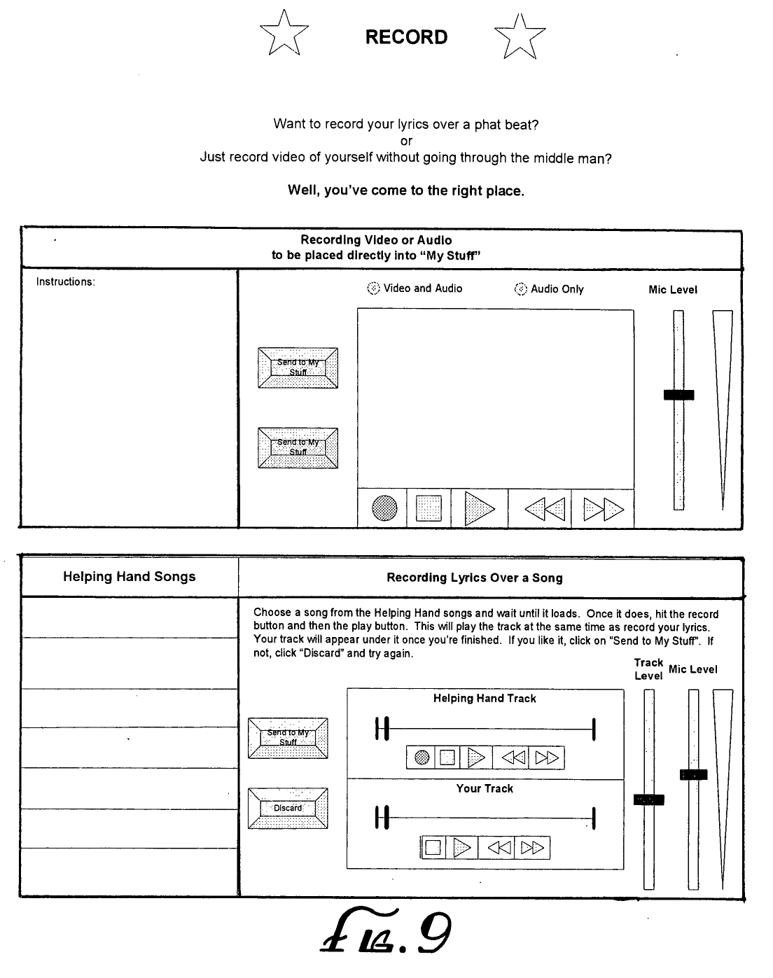

In other preferred embodiments, a recording feature is included in the contest system. With reference to FIG. 9, users can record video and audio of themselves and store it in the ‘my stuff folders. Further still, a user can select a song from a listing of available songs and record a track into the song, such as lyrics. In still other embodiments, the online contest system is coupled to other media outlets, such as television. For instance, in some embodiments, exceptional players will be selected for performance on a related television show. The recordings of higher level performances, if so desired by the performer, can also be made available for casting directors, music producers, and many other entertainment executives or relevant persons.

Further still, in another preferred embodiment, the contest system can be used to create a multimedia presentation, such as television or online show, wherein each scene or series of scenes can be played by different people performing in the role of the various characters of the show. In preferred embodiments, the show is created by selecting the winners of a series of auditions utilizing the contest system as described above for each scene or series of scenes. The content submitted by each winning contestant becomes the ‘show’ and is displayed in seriatim, weekly or daily for example, as winners are selected, such that the contiguous display creates the ‘show’. In preferred embodiments, multi-person scenes which are created from different contestants would be edited together using commonly understood editing techniques. In creating the scenes, each contestant would be instructed regarding staging, for example, where to look and direct their attention. In instances wherein the characters in the scene would be required to touch, for example, kiss or shake hands, the contestant for each character would be instructed to insert a ‘prop’, that is, a substitute person that is not a contestant. Upon presentation of the combined scene, the first character would be viewed as interacting with the substitute person until the second character recited a line or another action was taken. For example, if character A were to kiss character B, the contestant performing the part of character A would film a kiss with the substitute person. When character B was required to perform some other action, the scene would revert to the video of the contestant performing the part of character B. Accordingly, multi-scenes could be created.

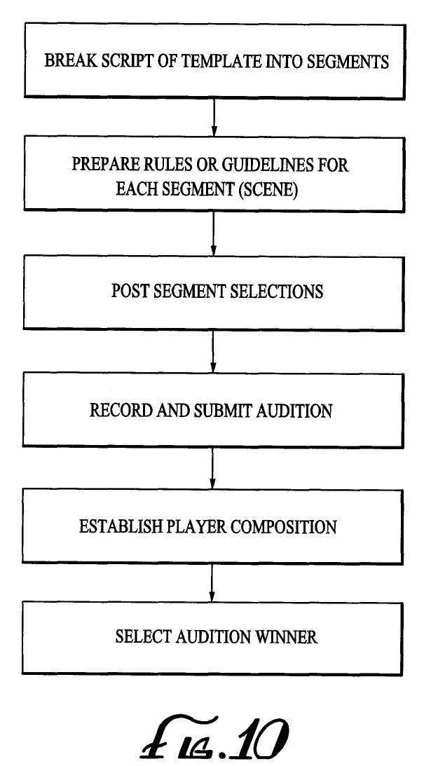

With reference to FIG. 10, prior to creating the show, the script or template for the show is broken into segments 120. Each segment can be a single scene or a series of scenes. Rules or guidelines are written for each scene 122, wherein the guidelines are intended to direct the participant actors in creating the scene. For example, guidelines can include any type of information relevant to creating the scene in accordance with the storyline, including, but not limited to, information regarding the nationality of the character, the dress of the character, the personality of the character and required props. The guidelines will promote the continuity of the show between scenes. For instance, if character A is a blonde, the guidelines for each subsequent scene with character A would indicate her as a blonde so that all persons auditioning for character A would either be blonde or wear a blonde wig.

The segments selections, including the script for the segment and guidelines, are posted in a category, such as, a television show category 124. Users or players select the scene or scenes for which they wish to audition, record their audition and submit it for competition 126. In accordance with the described embodiments above, the player is assigned a match in a competition level and competes against other players 128. The audition is conducted throughout a predefined number of levels until a winner is selected for that scene 130. The winner's audition entry is used as the show segment. In some embodiments, if the contest has not progressed through the number of predefined competition levels, but the show is scheduled to be aired, the player having the highest cumulative points or achieving the highest level will be declared the winner and the audition associated with the winner will be aired as a part of the show. The auditions are conducted for each of the segments such that the multimedia presentation is completed. In some preferred embodiments, the show is an ongoing show, such as, for example, a soap opera.

The attached figures forming part of the written description depict various aspects and variations on embodiments of the invention. Although the invention has been described in accordance with various preferred embodiments, the disclosure is not intended to be limiting, as to other features or variations. For instance, in some preferred embodiments, videos that are uploaded into the judging system can be embedded in electronic mail or in other third party websites. These videos or video clips will still be transmitted from the provider computer. In addition, uploaded videos that are embedded or electronically transmitted in electronic mail messages can contain advertisements within the video, for instance at the beginning or at the end, be embedded in the video player that is transmitted with the video (as is commonly understood to those skilled in the art), or can contain links to an advertiser's websites. Additionally, banner advertisements can also be included in the video player. Accordingly, if a video or video clip is transmitted via electronic mail as a link, or as embedded code on another web site, viewers viewing the video will be exposed to the advertisements regardless of where the video is transmitted. Further, the advertisements will be ‘clickable’, thereby allowing the advertiser to directly transmit the user to the advertiser's web site or selected destination. Although all variations of embodiments of the invention have not been set forth, the foregoing is intended to cover all modifications and alternative constructions falling within the spirit and scope of the invention.

What is claimed is:

1. A method for evaluating submissions of participants for entry into an event in a judging system, the judging system being operated on a network computer having a provider computer and a user computer, the provider computer and user computer being in electronic communication, the judging system comprising a plurality of competition levels, the competition levels ranging from a first competition level to a highest competition level, comprising:
registering a predefined number of participants for the first competition level;
providing an electronic forum for viewing the submission of each participant, wherein access to the forum is restricted to the predefined number of participants;
receiving, from each registered participant, evaluations of the performances for each of the remaining participants; and
identifying a winner of the first competition level based on the results of the evaluations.

2. A method as claimed in claim 1, wherein evaluations of the submissions comprise ranking each of the submissions and assigning a predefined value to the placement in the ranking.

3. A method as claimed in claim 1, wherein evaluations of the submissions comprise vetoing a submission of a participant.

4. A method as claimed in claim 1, wherein evaluations of the submissions comprise one or more of vetoing a submission of a participant, ranking a submission or assigning a predefined value to the placement in the ranking.

5. A method as claimed in claim 1, further comprising predefining a time period for receiving evaluations from each registered participant.

6. A method as claimed in claim 1, wherein identifying the winner comprises:
identifying, for each submission, whether a performance has been vetoed by a participant;
summing, for each submission, the assigned values received by the submission from each of the participants;
identifying the participant receiving the highest summed values; and
determining whether the submission of the participant receiving the highest summed value has received a predefined number of vetoes; and
if the submission of the participant receiving the highest summed value has received the predefined number of vetoes, identifying, as the winner, the participant associated with the next highest summed value, wherein the performance of the participant with the next highest summed value has not received the predefined number of vetoes;
if the performance of the participant receiving the highest summed value has not received a predefined number of vetoes, identifying, as the winner, the participant receiving the highest summed value.

7. A method as claimed in claim 1, further comprising registering the identified winner of the first competition level in a second competition level, wherein the second competition level is limited to a predefined number of participants.

8. A method as claimed in claim 1, wherein the event further comprises a plurality of matches within the first competition level, further comprising registering the identified winner of the first competition level in a second competition level, wherein the second competition level is limited to a predefined number of participants and wherein each of the participants registered in the second competition level are identified winners in a first level competition match.

9. A method as claimed in claim 1, further comprising defining a maximum number of lives a participant can lose in an event that determine an automatic loss of the event by the participant, wherein the loss of the event requires the participant to reenter the event at a new first competition level.

10. A method as claimed in claim 1, wherein at least one of the predefined number of participants is a representative of the owner of a submission, wherein the submission has been made available by the owner for entry into the judging system by third parties.

11. A method for evaluating the performances of contestants in a contest, the contest comprising a plurality of matches and a plurality of competition levels, comprising:
registering a first set of predefined number of contestants for a first competition level in a first match;
registering a second set of predefined number of contestants for a first competition level in a second match;
providing a first forum for viewing the performances of each contestant in the first match, wherein access to the forum is restricted to the predefined number of contestants in the first match;
providing a second forum for viewing the performances of each contestant in the second match, wherein access to the forum is restricted to the predefined number of contestants in the second match;
receiving, from each registered contestant in the first match, evaluations of the performances for each of the remaining contestants in the first match;
receiving, from each registered contestant in the second match, evaluations of the performances for each of the remaining contestants in the second match;
identifying a winner of the first competition level of the first match based on the results of the evaluations;
identifying a winner of the first competition level of the second match based on the results of the evaluations;
registering at least one of the identified winners of the first competition level in the first match and the second match in a second competition level, wherein the second competition level is limited to a predefined number of contestants and wherein each of the contestants registered in the second competition level are identified winners in -the first level competition of a match.

12. A method as claimed in claim 11, further comprising repeating the steps of registering, providing, receiving, identifying and registering at least one of the identified winners for each match in each of the subsequent competition levels until a winner is identified at a final competition level.

13. A method as claimed in claim 12, further comprising:
providing a forum for viewing the performances of each contestant in the current match, wherein access to the forum is restricted to the predefined number of contestants in the current match and to any of the previously registered contestants in the prior competition levels; and
receiving, from at least one previously registered contestant in the prior competition levels, evaluations of the performances for each of the contestants in the current competition level.

14. A contest system for evaluating performances of contestants in a first contest having a plurality of competition levels, each competition level having a plurality of matches, the system having a provider computer and a user computer, the provider computer and user computer being coupled in communication, comprising:
means for registering a predefined number of contestants for a first competition level;
means for providing an online forum for viewing the performances of each contestant, wherein access to the forum is restricted to the predefined number of contestants;
means for receiving, from each registered contestant, evaluations of the performances for each of the remaining contestants; and
means for identifying a winner of the first competition level based on the results of the evaluations.

15. A contest system as claimed in claim 14, further comprising:
means for registering additional performances of the contestants in the contest system, at least one of the additional performances being available to be entered into a first competition level in a second contest;
a user interface having a link, wherein the link identifies that a first contestant desires to form an association with at least one of a second contestant's performances, wherein the activation of the link by the first contestant automatically creates an association between the first contestant and the second contestant's selected performance.

16. A contest system as claimed in claim 15, further comprising a database, wherein the database is configured to store contestant information of the first contestant and the second contestant, and wherein the association between the first contestant and the second contestant's performance is the listing of the identification of second contestant's performance in association with the first contestant's stored information.

17. A contest system as claimed in claim 16, wherein the user interface further comprises a series of web pages, the web pages being configured to allow the first and second contestant to access contestant information for the other.

18. A contest system as claimed in claim 17, wherein contestant information comprises at least one of the following group: performance information, competition information, association information between the contestant and other contestant performances.
